(19) United States
(12) Patent Application Publication
(10) Pub. No.: US 2004/0210445 A1
(43) Pub. Date: Oct. 21, 2004

(54) Method and system for specifying and implementing business applications

(76) Inventors: Luca Veronese, Rovigo (IT); Renato Carraro, Padova (IT)

Correspondence Address: MODIANO, JOSIF, PISANTY & STAUB, EUROPEAN PATENT ATTORNEYS U.S. PATENT AGENTS, Via Meravigli, MILANO, 16-I-20123, IT

(21) Appl. No.: 09/825,960

(22) Filed: Apr. 5, 2001

(51) Int. Cl. G06F 17/00; G06F 7/00; G06F 17/60; G06F 9/44

(52) U.S. Cl. 705/1; 707/104.1

(57) ABSTRACT

A high-level method and system is provided for effortlessly specifying and implementing complex business applications to be integrated within an e-business environment, decoupling the specification of the business rules driving the application and the user interface components from the actual implementation and generation of the software package.

### BACKGROUND OF THE INVENTION

The present invention relates to a method and apparatus for specifying and implementing business applications, particularly, but not exclusively, for integration within an e-business environment.

The fast pace at which technology has developed in the last decade and the fast growing of the Internet have turned most of the original business systems into computerized network systems.

A typical business application is built on a three-layer software architecture: the first layer comprises the data warehouse of the system, the second layer comprises the application core, which implements the business rules driving the application in a software package executable on the specific operating system of the destination hardware platform, and the third layer is the graphical man-machine interface, which allows the operator to interact with the application and the database layer.

Generally speaking, the graphic user interface awaits input from the user, displays visual information and exchanges data with the underlying application, working on top of the database system to which business rules are applied.

Input comes from user actions on a keyboard or from some pointing device to select specific areas of the display screen, usually referred to as active fields, while other areas of the screen, referred to as passive fields, depict information for the user. The particular presentation of active or passive fields on the screen is called the layout of the GUI.

During a work session, the user performs a series of input actions, called input events, usually classified into low-level and high-level events. Low-level events, like detecting that the mouse has been moved or a button has been pressed, are captured and processed by the computer platform, for example by the operating system itself, and are mapped into high-level events, like the sliding of a scroll-bar or the selection of a menu item.

In response to an event, the application core performs one or more actions. Actions are of different kinds: for instance, visual actions display messages, open windows and display menus, providing, in general, immediate visual feed-back, while other actions make the application read or write data to/from the data warehouse or perform computations.

The described combination of input/output events and actions constitutes the dynamic behavior of the application.

In order to build a full system, it is required that a team of analysts and programmers design and implement the database layer, the business rules controlling such a database, the application core specific to a certain operating system and the graphical interface through which the final user can control the business application. The behavior of the business rules and the behavior of the GUI must be programmed separately by writing conventional code. If a certain rule needs to be changed, the programmer must write or rewrite a certain piece of code, check which parts of the application are affected by such a change, re-implement a suitable graphical interface taking into account the new rule, create a new software package and re-test it thoroughly.

Business applications are essential for a widespread and effective use of mainframe and client-server management systems. However, it has been shown that their current design techniques are not satisfactory, resulting costly, subject to errors and very hard to revise and to extend. For these reasons, new business development models shall be oriented to flexibility and speed of change, so as to provide competitive advantage.

Moreover, the growing affirmation of the Internet as a business tool, and the new vision of the extended supply chain (from intra-company to inter-company) strongly demand for new development methodologies, which be both rapid and easily manageable and modifiable by the users.

Therefore, there is a strong need of new methods and tools allowing to define the organization of companies, their business processes and their business rules in a declarative manner.

### SUMMARY OF THE INVENTION

The principal aim of the present invention is to give a solution to the above mentioned problems, providing an application development system that allows to specify new business rules driving the business application, to modify the dynamic behavior of the related GUI and to generate new application modules in an easy and effective manner, with no intervention of specialized analysts or programmers.

In more detail, the principal aim of the present invention is to provide an improved method and system to build mission critical applications with complete business process automation.

Within this aim, an object of the present invention is to achieve full independence between the application specification and the multiple possible implementations of the application, including its dynamic behavior, detaching the specification of the business rules and of the user interface components from the specification and implementation of the application modules and allowing the complete, organic specification of the dynamic behavior of the runtime application modules.

In this approach, the business rules are the cornerstone of the development, being the principal means to formally and declaratively describe business requirements. Business rules describe what has to be done by the application independently of how the core application would be written in terms of procedural programming. Business rules are defined as complete, self contained statements about the business and they can be easily identified and added to or removed from an existing system by means of a Visual Editor, which guides the developer in the steps of writing a syntactically correct rule.

The terms referenced by a business rule are business rules themselves. They can be related together for example by algebraic or logical operators to create more complex definitions of business requirements. Business rules are expressed in the language of the business, not in the language of computers, so that they can be understood and written not only by programmers but also by business professionals. This shifts most of the development away from programmers and towards business professionals, rendering, at the same time, the expression of software independent of software technology used for the actual implementation of the application.

Another object of the present invention is to allow the user to focus on business skills rather than programming skills.

Yet another object of the present invention is to allow companies to create software based organization either on top of their existing information technology infrastructures and business systems or as a newly implemented integrated information system.

This aim, these objects and others which will become apparent hereinafter are achieved by a computer method and system for specifying and implementing business applications comprising a data warehouse, a repository of meta-data, an application core and a graphical user interface, using modular, intercommunicating objects, comprising the steps of:

providing a plurality of database tables within said data warehouse;

starting from said plurality of database tables, generating a number of business objects stored in said repository;

accepting input from users defining a plurality of business rules associated with said business objects;

parsing and normalizing said input from users and updating said business objects within said repository;

generating source code for said application core and said graphical user interface.

Conveniently, said data warehouse may be defined through an Entity-Relationship (E-R) diagram or UML diagram or by directly entering the necessary DDL to create the database tables. A formal language is provided to write business rules. Visual tools are provided to assist the developers in entering input data.

Advantageously, said business objects comprise views, attributes, relations, methods, constraints, domains and sequences.

### BRIEF DESCRIPTION OF THE DRAWINGS

Further characteristics and advantages of the present invention will become apparent from the following detailed description, given by way of a non-limitative example and illustrated in the accompanying figures, wherein:

FIG. 1 is a block diagram showing the data-flow of the development process according to the present invention;

FIG. 2 shows the first step of generating business objects from database tables;

FIG. 3 is a data-flow illustrating the steps performed to evaluate meta-data according to the present invention;

FIGS. 4 to 10 show schematic views showing illustrative examples of data handled through the present invention, as clarified in the following description.

### DESCRIPTION OF THE PREFERRED EMBODIMENTS

The present invention is based on three main features: business rules oriented application development, replaceable pre-built development frameworks and GUI development and generation of runtime applications based on standard Internet browsers.

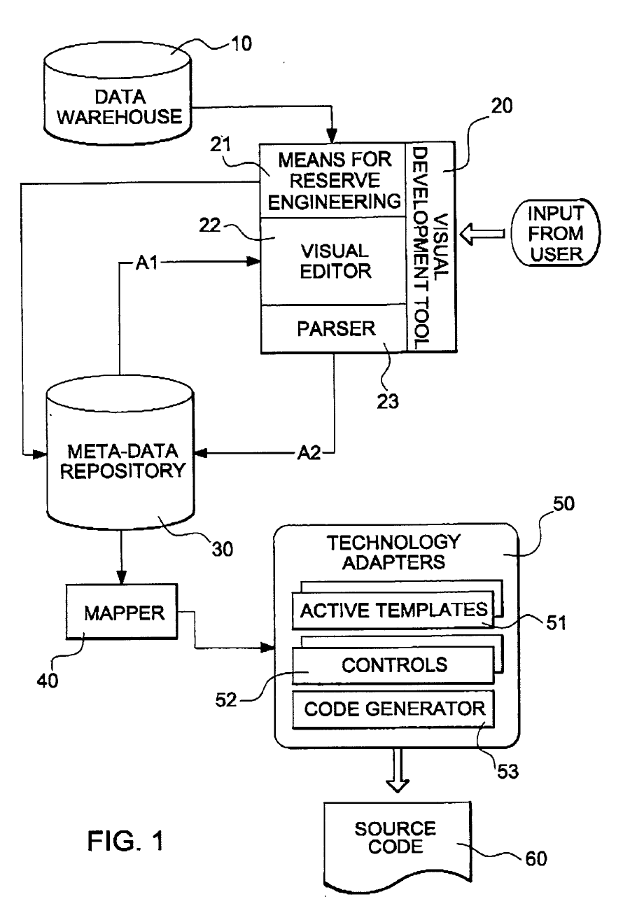

The process according to the present invention is shown in FIG. 1: at the end of the process all the main components of the runtime application are automatically generated.

Particularly, FIG. 1 shows a Data Warehouse 10; a Visual Development Tool 20 comprising means 21 for reverse engineering a database 10, means 22 for accepting input from the developer (referred to as the Visual Editor) and a Parser 22; a Repository 30; a Mapper 40 and Technology Adapters 50.

The Database or Data Warehouse 10 comprises a set of tables 11 defined through traditional means and tools. In a preferred embodiment, the database is defined using a commercial product like an Oracle database package, but any kind of tools and systems accomplishing the same purpose can be used. Moreover, the source database 10 can be any existing database already in use by a company, with no need to redefine or rewrite its structure from scratch.

The Visual Development Tool 20 is provided to the developer to perform all sort of actions aimed at defining the application behavior. The tool is partitioned in three main sections: means 21 for reverse engineering the database, means 22 for accepting new data from the user and means 23 for parsing and normalizing the data that the user has entered.

All of these modules work on and interact with a repository 30 of meta-data, which acts as a global container of data stored in a proprietary format supplying all the information needed either by the Visual Editor 22, to let the developer enter new data and rules in a declarative manner, and by the tools in charge of generating the final application modules, namely a Mapper 40 and Technology Adapters 50. The repository is implemented as a database containing all the information that describes the business in the form of meta-data, as opposed to information (data) required by the business for information processing purposes. Particularly, the repository 30 is divided in three layers:

a. the data layer, which contains the data definition and structure of the database;

b. the business objects layer, which contains all the objects and rules driving the application;

c. the user interface layer, which contains information defining the appearance of the GUI.

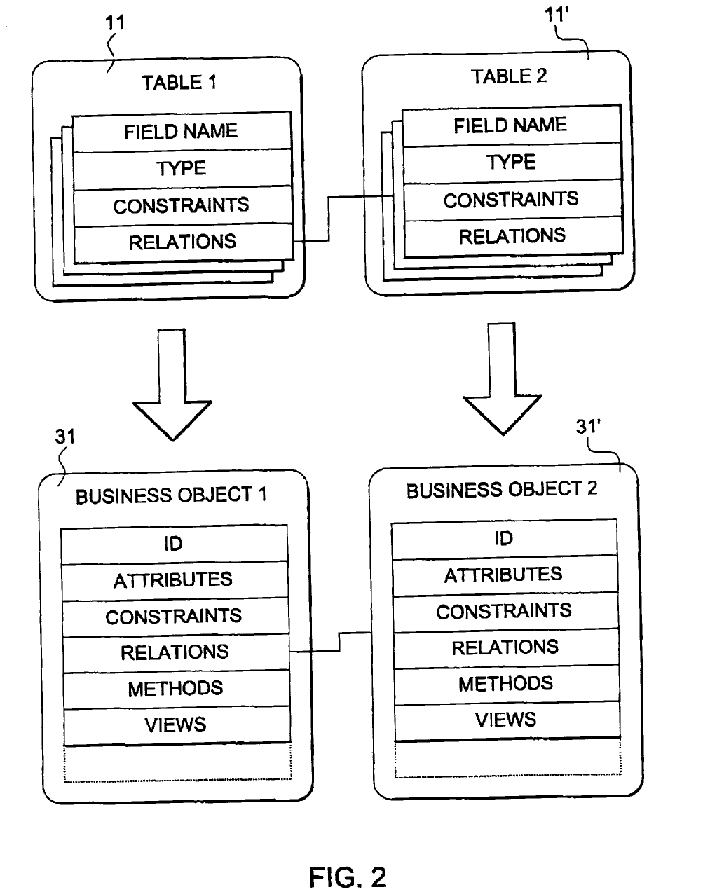

Referring now to FIG. 1, the data-flow is as follows. First of all the reverse engineering of a source database 10 is performed. Means 21 for reverse engineering the database are provided in the system and are activated by the developer through dedicated means in the Visual Development Tool 20. Such means 21 scan the database structure of the database selected by the developer and generate a number of objects 32 in the repository 30, each of which is called a business object and comprises a number of properties and methods. Particularly, one business object 32 is generated per each table 11 found in the database 10, and a name derived from the name of the table is automatically assigned to the newly generated business object. The process is schematically shown in FIG. 2. The so created business objects represent the basic entities of a business, for example “customers”, “suppliers”, “orders” and so on, each of which, as said, is created starting from a corresponding table in the source database. Before describing business objects, therefore, it is useful to remember that database tables comprise a number of fields characterized by a set of properties. Usually, the main properties of a field are:

a name, uniquely identifying the field within the table;

a type, identifying the kind of data that is stored in that field. For instance, typical types are CHARACTER for storing alphanumeric sequences of characters, NUMBER and FLOAT, for storing numeric values, DATE for storing dates, LOGICAL for storing boolean values (true, false), BLOB or MEMO used to store sequences of alphanumeric characters of undefined length, plus a number of field types which are specific of different database systems;

a length, which tells how many bytes can be entered in a record for that field;

constraints, which define which values are or are not valid for a field, for instance a numerical range.

Moreover, fields can be logically linked to other fields defined in a different table, the so-called referential integrity constraints: when such a relation is defined, the value of one or more key fields are used to reference a row in another related table (e.g. the ORDERS table may contain a CUST_ID field that references the CUSTOMER table). In this case the RDBMS can guarantee that the key values correspond to existing rows in the related table.

Similarly, each business object 22 is described by attributes, which are properties of the business object, which store values. By default, one attribute is generated in the business object for each column in the source table corresponding to the business object to which the field belongs. In turn, an attribute comprises a name, generated starting from the corresponding field in the source table, a description, which describes, for the developer's convenience, what is stored in the attribute value.

Moreover, attributes can be persistent and/or derived or linked to a sequence that generates unique keys for a business object, and may be linked to rules, explained below, for instance to define when an attribute is mandatory, what its default value is, if the attribute is a derived one (i.e. not a constant one) or when it can be changed. Attributes can also be parameterized, for example an availableStockOnDate attribute can be defined for a given product to return the available stock of a given product on a given parametric date.

Attributes are also characterized as belonging to a domain, term that defines a type of data, characterized by a certain number of properties. This is useful to build custom types according to the developer's will, avoiding redundancy and making data definition much neater. For instance, one could define a new data type “PRICE” and set it to a FLOAT composed of 6 ciphers, a dot, and two more ciphers.

An example of attributes is given in Table 1.

TABLE 1

| Name | Description | Column | Table | Domain |
|---|---|---|---|---|
| artClientCod | Code acting | 37002 | ART_CLIENT_COD in | 22101 |
| | as primary | | CONTRACT_ITEMS | |
| | key for | | | |
| | client | | | |

Business objects further comprise relationships, which reflect the table referential integrity constraints into corresponding business object properties. For example, “customer places orders” defines a one to many relationship between customers and orders. At the time the source database 10 is scanned by means 21, existing constraints between two or more tables are replicated as relationships between the corresponding business objects. Relationships between business objects can also be defined independently of database referential integrity constraints. This allows the developer to establish any required navigational paths between the various business objects.

Constraints can be defined on business objects to verify that the current business state is correct. For example, a constraint can be defined to guarantee that an order cannot be shipped before it is approved or cannot be taken if a product is not available in stock.

A business object also contains a boolean flag, “IsValid”, which tells the system whether the business object definition is consistent with the other data items contained in the repository so that the business object is ready to be generated into some form of software component. The repository application software automatically manages this information.

A business object is further characterized by Views, Methods, Processes and Rules.

Views are declarative, technology independent descriptions of user interfaces, which can be dynamically translated into various types of content or messages, like HTML pages, XML messages or WML stacks. They will be described in more depth later.

Methods, or operations, describe how the state of the same or other business objects related to it must change when the method, or operation, is executed.

Methods allow definition of complex business object manipulations. A method is a sequence of one or more operations. Each operation can be an object creation, modification, destruction or the execution of another object method. Each operation can be executed conditionally based on user-defined restrictions. Each operation can also be executed on another business object (a single instance or many instances), by specifying a relationship path to reach the target object.

A method can have zero or more parameters, which can belong to any domain. In particular a parameter can be an object reference.

A method can also have pre-conditions and post-conditions. A pre-condition is a restriction on the execution of the method and it is checked before the method operations are executed. If the pre-condition is false for a specific instance, the method fails. The outcome of the failure depends on the method type as will be illustrated shortly. A post-condition is the same as a pre-condition, but a post-condition is checked after the method operations have all been successfully executed. This allows the method to check boundary conditions or assertions that must be true at the end of the method execution.

A method can be defined as an instance method or a class method. An instance method is executed on a particular business object instance, so it will always have implied parameters that reference the primary key of the business object. An instance method failure causes the transaction to roll back. A class method instead is not executed on a single instance, but is executed on all instances that satisfy all method pre-conditions. If an instance does not satisfy the method's post-conditions or fails in any other way, then the operations on this instance are atomically rolled back but the method as a whole succeeds. This behavior allows flexibility in business logic specification since it is possible to execute a method on a set of objects that can fail globally (instance method called on a set of object instances), or that always succeeds but can fail locally (class method).

An example of a class method is an invoice method on a shipment business object. A precondition may be defined asserting that a shipment must be invoiced only if it has not been already. In this way all un-invoiced shipments will be invoiced at once. An example of an instance method may be a confirm method on an order business object. The method will confirm only a given order sent in as a parameter, when it is undesirable to have all orders confirmed as a whole.

Events are another repository construct. Events are facts of interest for the business that cause some action to occur whenever they happen. Events are of three types: operation-based, condition-based and time-based. An operation-based event happens whenever a given operation is executed like creating, modifying or destroying an object or calling a method. The event is fully specified as happening before or after the given operation. This allows operations to remain essential, while the consequences of those actions depending on particular business requirements are connected to operation-based events instead of being hard coded inside methods.

Condition-based events are defined through a boolean expression that has to be checked when some operation is executed that may affect its value for a given business object instance. An example may be the classical product reorder business rule: a product must be reordered if the quantity on stock falls below a given product reorder limit. In this case the event stockUnderLimit may be defined on the stock business object with the expression: “quantityOnStock<product.reorderLimit”. In this case any transaction that affects the quantityOnStock and reorderLimit attributes should check the expression to verify the event's occurrence.

Time-based events are identified by the passage of time. For example, to send invoices to customers every Friday at 19.00 or to automatically cancel an unconfirmed customer order after three days from its acceptance.

To connect events to actions to be executed, another repository construct is defined in the form of Triggers. A trigger defines an action to be executed when an event occurs. Events by themselves do nothing. The occurrence of an event may trigger many different actions to satisfy many different business requirements. A trigger may call a method or initiate a workflow, for instance the previous reorder example where a trigger fires a reorder of a given product whenever the “stockUnderLimit” event occurs.

A business process is described by a set of workflows necessary to accomplish a certain process. Each step defines the event that triggers the step, the information received, a set of rules defining automated processing or a business actor that is the destination of the message. Business actors are classes of users or computer services that know how to process an incoming message, which can be a view, and constitute the active parties of the process. Each message can contain operation links to further trigger additional steps in the process (or in other processes). In other cases the message may be a request of additional information that, once stored back into the database, can trigger other business process steps.

Additional types of rules can be selected from a predefined set of standard rules and applied to attributes or view items, to define the behavior of the application in response to actions normally performed on a database, like adding, deleting or modifying a record or to specify the behavior of the user interface.

The expressions that make a business rule definition are stored, together with business objects, in the repository 30 as parse trees.

The need to store business rules in a shared repository originates by the fact that business rules must be processed by the development system, so there must be a way to represent them (a meta-model) and a way to store them in a form that allows efficient and flexible querying and transformation. According to the preferred embodiment of the present invention, a relational database is used to store the business rules, which allows to use an HTML based user interface to enter, query, cross reference, analyze, share and document them.

As mentioned, a new formal language is introduced in order to collect the business requirements from the developer, who is guided by the Visual Development 20 tool in the creation of new rules. A rule can address any object and any data contained within an object and relate it to other data or let start certain actions when a selected or user defined condition is met. As expressed by arrow A1 in FIG. 1, the Visual Editor 22 retrieves data from the repository to let the developer define new rules.

A business rule is a wide concept, which embraces all the relations, constraints and rules that make up the application behavior.

For instance, a business rule may state that an order from a given customer can be accepted only if the total order amount does not exceed the customer's remaining credit limit. The system according to the present invention allows this rule to be directly expressed in a declarative formalism, levying the developer from the burden of analyzing the impact of its implementation on already existing software, i.e. which software modules are affected and which changes have to be made to those modules in terms of code. In fact, as it will be shown later, the system is able, from the formal rule definition, to automatically identify and (re)build the software components required to implement the rule.

The most complex rules require being defined using expressions. For example, a rule that states how a derived value is computed must be defined using some form of algebraic expression like “quantity*price”. To define expressions, as said, a formal language is introduced. This language is business object context sensitive. This means that any term that makes up an expression has a specific meaning in the context of a specified business object. For example, the term “name” may mean the name of a customer or a supplier or even an employee. It is the context business object that unequivocally identifies the meaning of the term “name”. This simplifies the syntax making it more similar to natural language where we generally use terms whose meaning is clear in the context of the sentence.

Given a business object, a namespace is identified where a given set of terms have a specific meaning. This set is composed of:

1) the name of the business object;

2) the names of all the attributes of this business object;

3) the names, in the parent wise direction, of all the relationships where the context business object is the child, that is direct references to other business objects (e.g. customer of an order);

4) the names, in the children wise direction, of all the relationships where the context business object is the parent, that is collections of related business objects (e.g. orders of a given customer);

5) the names of all the views of this business object;

6) the names of all the methods of this business object.

This set is only a non limitative example of all the possible types of repository elements that make the namespace of a given business object.

To reference an attribute, view or method belonging to another business object from the current one, a relationship path is used. A relationship path is a set of valid relationship names connected by the “.” operator. For example, to reference the name of a customer from the order the expression “customer.name” can be used, where customer is the relationship between customers and orders navigated from orders to customers. It is necessary to use relationships to navigate between business objects since only a relationship carries the meaning on how the targeted business object must be identified. It is not uncommon to have more than one relationship between the same two business objects. An example may be an order having two relationships with addresses, shipping address and invoicing address. In this case, to reference the street of the invoice address something like to “invoiceAddress.street” would be written. Had we used business object names we wouldn't have been able to discriminate between the two types of addresses.

When a one to many relationship is navigated, a filter expression can be specified to apply some method or to display a view only for a subset of the possible instances identified by the relationship. For example, to display the “paymentInformation” view only for undue payments for a given customer, something like “payments(undue).paymentInformation” would be stated, where “undue” is a Boolean payment attribute that computes whether a given payment is undue or not, through a separate derivation rule.

To create more complex expressions, keywords, operators and functions like “AND”, “OR”, “NOT”, “>”, “=” or “max”, “min”, “count”, “substr” can be used. In this way complex functionality can be expressed. User defined functions can also be declared to the repository and used in expressions.

To better clarify the compactness and the declarative form of a rule, which, as said, is independent from its representation in terms of source code, the following example of a business rule is now given for illustrative purposes.

A businessman runs a firm, which sells wheat, and makes a contract with a reseller of flour, which allows the reseller to order a daily maximum amount of flour. Such maximum amount may be mutually expressed as a total amount in the contract form or as a sum of the amounts of single contract items. Therefore, if a contract specifies the total amount of flour that the customer wants to buy, it must not be possible to enter quantities for single contract items.

In a visual tool according to the present invention, this is expressed as a constraint on the ContractItems business object, for instance through the following syntax that reflects the adopted formal language:

(Contract.amount <> 0) => (amount=0)

(Contract.amount ==0) => (amount <>0)

wherein amount is an attribute defined for this Business Object and Contract is the business object that represents the whole contract. The => operator is the implication logical operator, so that the rule can be read as “if the contract amount is not zero then the contract line amount must be zero” and “if the contract amount is zero then the contract line amount must be nonzero”.

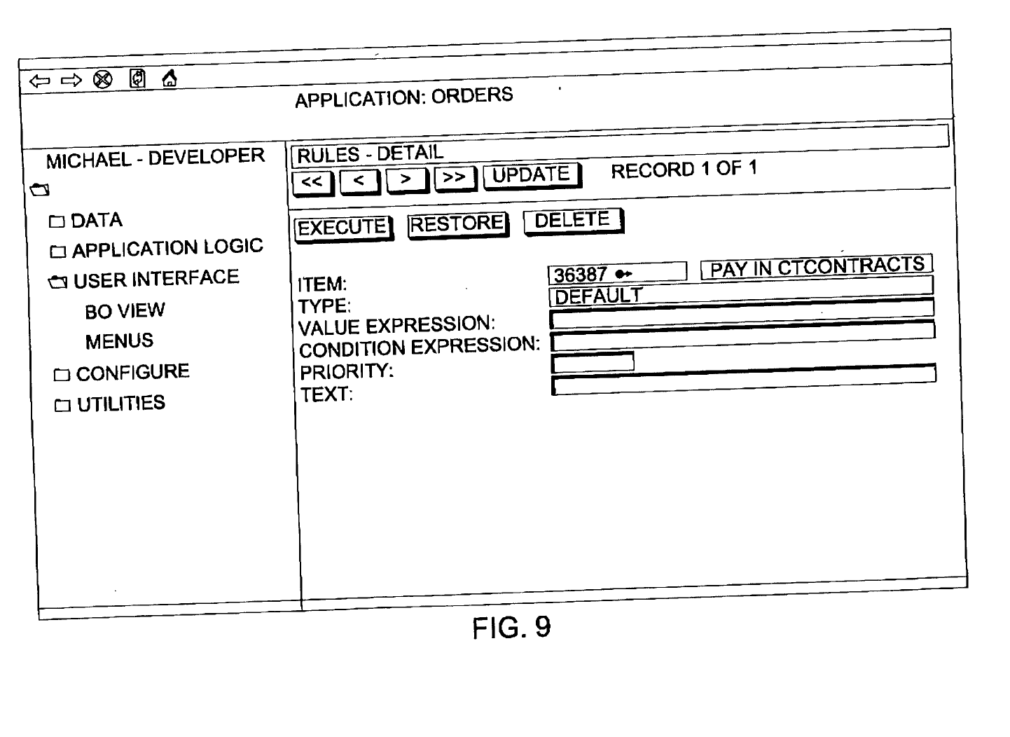

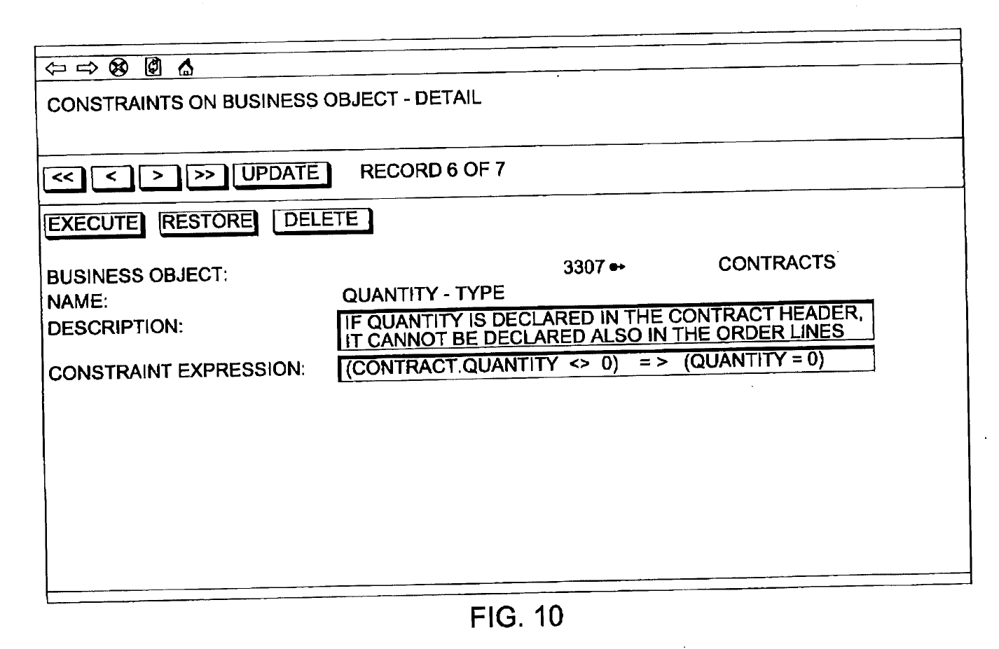

To actually write this rule, the following steps must be performed. First, by using the Visual Editor (a schematic illustration of which is given in FIG. 9 in a browser based implementation), a business object is selected form the list of available business objects, or a new one is created if necessary, a menu item “Constraints” is activated and the above rule text is entered, as shown in FIG. 10 and the above rule text is entered.

As soon as the developer has completed a business rule, the Parser 23 is activated and scans the newly defined business rule, double-checking its correctness and normalizing its representation in a corresponding parse tree before the rule is stored in the repository 30 and made accessible by other business objects or business rules.

The step of normalizing the data representation of business rules is needed in order to optimize expressions and make them uniform. This is achieved by expanding logical expressions linked by boolean or algebraic operators and all other rules addressed in the business rule under treatment. The step of parsing and normalizing business rules is expressed by arrow A2 in FIG. 1.

Once a new rule has been entered into the repository the impact analysis phase is executed. During this phase, depending on the changes made by the developer, some logic is applied to determine which application components have been impacted by this modification. These components are marked invalid and will be regenerated the next time the application is rebuilt. This impact analysis capability is an essential feature of a business rules driven development environment since it is the only way to ensure the declarative property of business rules. With automated impact analysis we decouple the specification of the application behavior from it's implementation in terms of software since developers are not required to know how the application components are implemented.

As soon as the developer has entered the required data and all the necessary business rules have been defined, the system is able to generate the final application modules for a variety of platforms.

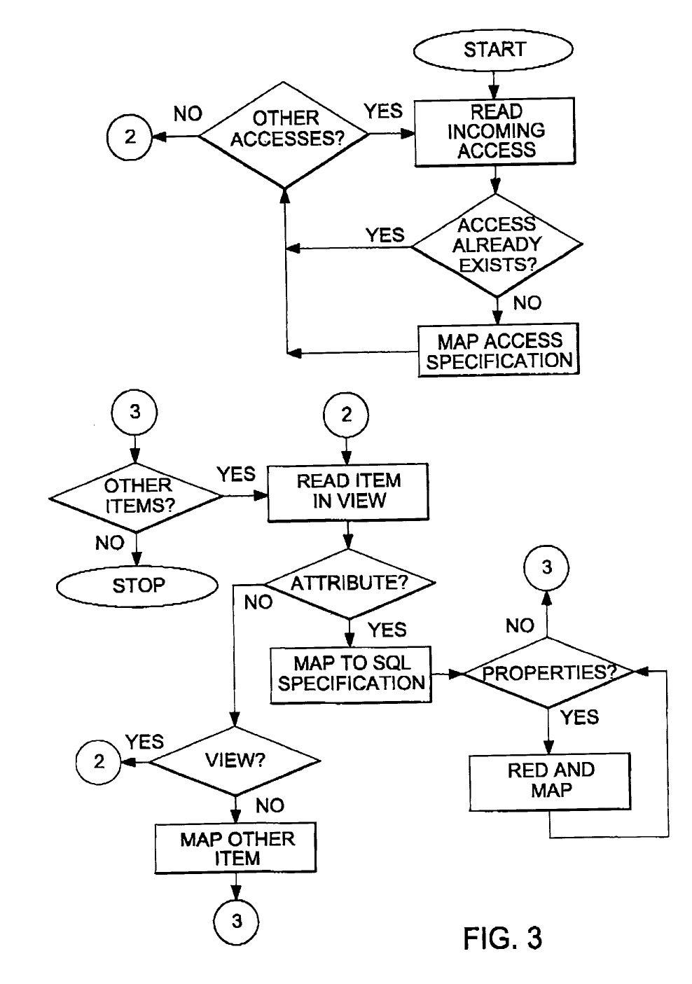

To transform the various rules into a set of optimized software components, the present invention uses a tool referred to as the Mapper 40, which is capable of interpreting the specification provided in the repository in the form of business objects and business rules and to understand the number, structure, behavior and interrelationships between the components. Particularly, the Mapper 40 takes the abstract (symbolic) domains of the semantic variables read from the parse trees and evaluates the impact of the referenced data on the final application. This is achieved according to the data-flow of FIG. 3.

The first two steps 310-320 of the data-flow are carried out by the Parser 23, and lead to a normalized parse tree.

The Mapper 40 is the component responsible for translating the declarative high-level business rules into low-level program specifications that can then be translated into source code by the Active Templates and Controls.

To describe the inner workings of the Mapper 40 an example of how a Business Object View is mapped is now explained. The other component type that is mapped is the Business Object itself and constitutes the business logic layer that is independent of a particular user interface.

To understand what the Mapper 40 does, it is first needed to describe in more detail how views are defined and what features they have.

Business Object Views define the specifications for the actual user interface and dialog flows of a given application function. Views are containers of items that define content. An item can define an atomic user interface element or be a reference to another view. In this way complex views can be defined through composition of other simpler views. This allows views to be maintained easily since a modification of a view automatically propagates to all other views that are composed out of it.

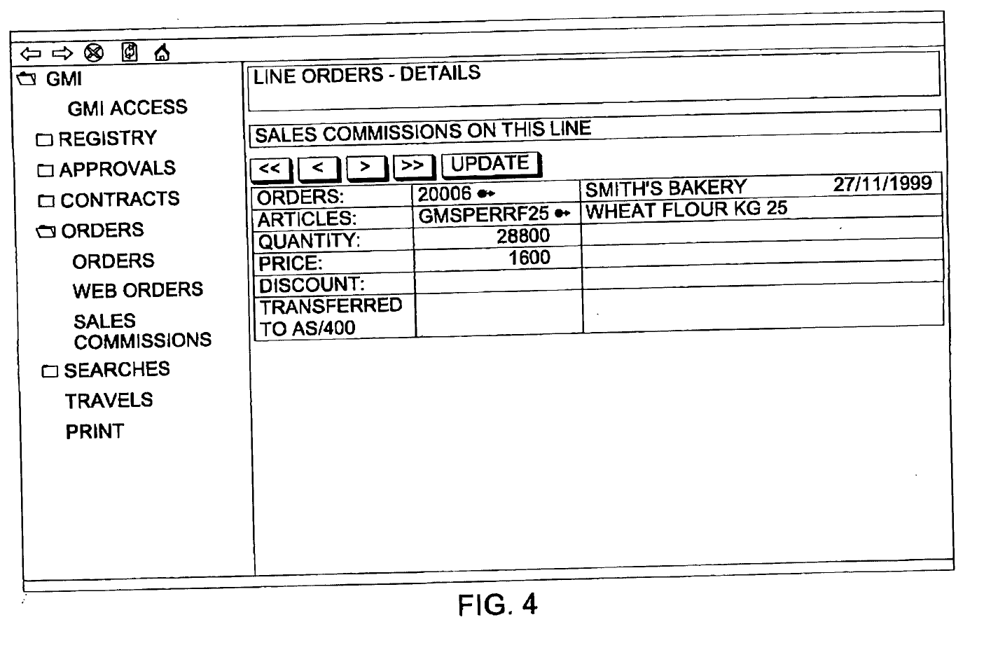

Another feature of views is they can automatically adjust their user interface to the paths used to access them. This means that the layout of the displayed information changes according to the type of query that has been requested on the view. For example, in FIG. 4, a view is displayed of an order item that has been accessed by primary key:

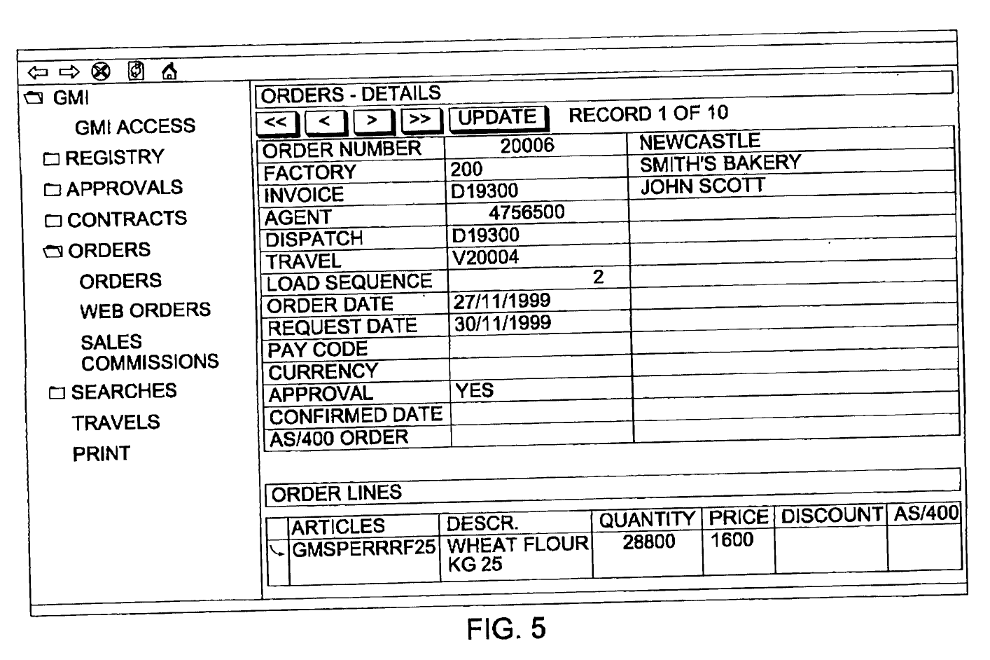

The same view when queried from the order is displayed as a detail of the order in FIG. 5, in which it can be seen that order header information has been suppressed and a tabular layout is used.

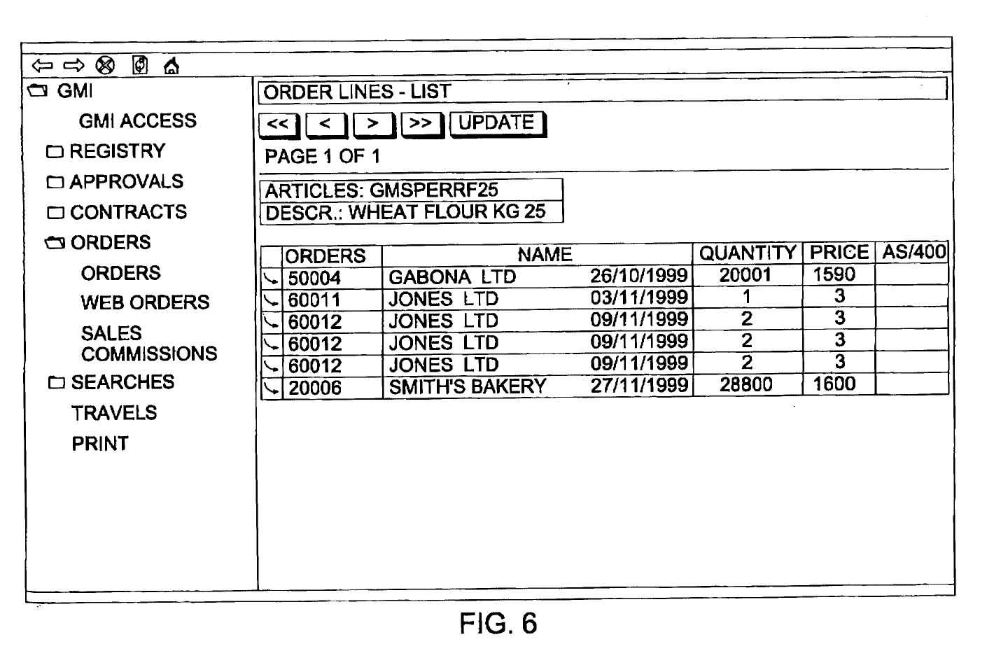

The same view can also be displayed by product, as shown in FIG. 6, the last row being the one displayed in the previous FIG. 5. It is possible to see that product information now is on the header while order information is now on the tabular list.

This morphing capability of views allows them to be reused independently of data access paths. This allows a single view to serve many purposes. This in turn significantly enhances maintainability since a change to the view is automatically propagated to any HTML page that the view can generate, while the current state of the art required to create different application modules for different access paths.

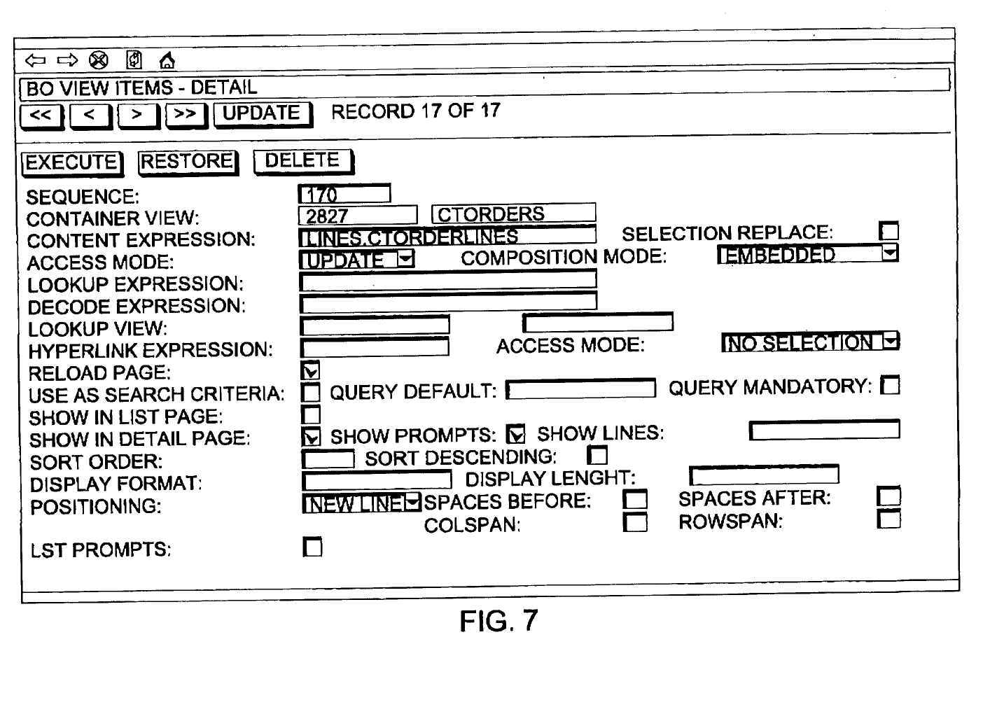

To the developer, all the programmatic requirements to make this happen are transparent. Developers simply define an item that references another view from the current one. It is the Mapper's 40 responsibility to identify the dependencies between the various views and to derive the necessary low level specifications required to subsequently implement those features. An example of how a link between different views can be defined is shown in FIG. 7.

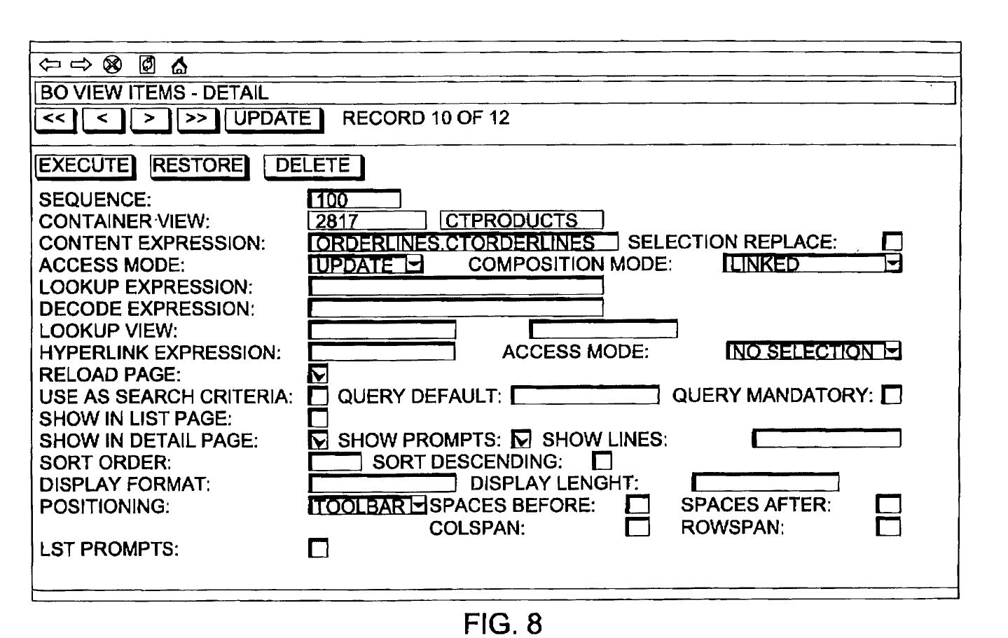

It is possible to see how the “ctOrderItems” view is referenced from the “ctOrders” view through a relationship called “lines” that allows navigation from the “Orders” business object to the “OrderLines” business object. The same happens for the “ctProducts” view that references the “ctOrderLines” view, shown in FIG. 8.

Here the “OrderLines” relationship is used to connect “ctProducts”, the product view, to “ctOrderLines”, the order lines view. This displays the order lines for this product.

It is possible to see that the definition given by the developer to connect the views is purely declarative. No code needs to be written in order to obtain the desired result.

Going back to the inner workings of the Mapper 40 we can now describe how the mapping process works for views. This is only a non limitative example of the kind of algorithms used internally by the Mapper 40.

Mapping a view happens in two steps. In the first step all incoming accesses to the current view from items belonging to other views (or even the same view in case of recursive relationships) are searched and for each one of them an access specification is created. A View is responsible for the specification (and subsequent implementation) of all the necessary access criteria requested from all of its callers. For instance, in the above example, the “ctCommesseR” view is responsible for the implementation of at least three access criteria: by key, by order and by product.

An access specification defines the actual connection between the caller and called views and the filter, join, and bind criteria required to actually perform the query. View Accesses are shared so that if a compatible access criterion is used from different items of different calling views then the same access construct can be used. This reduces the amount of generated code since for each access SQL code and query management programming logic must be generated and it would be redundant to create multiple identical procedures for identical access patterns. So an access can have multiple callers and the Mapper is responsible for identifying compatible access patterns, automatically identifying and optimizing the required bind parameters. All of this information is registered in the repository so that inter module calls can be generated subsequently using the correct procedure/method names and parameters in the correct order.

The second step in view mapping consists in mapping the items belonging to the view, recursively mapping any referenced view's items. In this way the full set of required information items can be identified. Part of this process is described in FIG. 3.

The goals of this step are:

1. to specify all data access requirements for the view in order to be able to subsequently generate efficient SQL to retrieve the data;

2. to identify all interdependencies between the user interface items so that user interface events can be managed and translated into actual actions that implement the developer specified business rules;

3. to identify updateable items so that it will be possible to generate the correct sequence of Business Object API calls necessary to update all the underlying database tables once the user submits the transaction (Views support automatic multiple table updates in the same transaction).

As concerns the first goal, any expression that references data in the view, items and attached rules is mapped into the view data access specification. This means any required tables, joins and columns or derived expressions are identified and mapped to the data access specification so that all the required data can be fetched from the database in a single round trip to the server. This optimizes performance on a networked configuration where the application must access the database on another network-connected machine. This also means that not only the data necessary to build the user interface is retrieved but all the data that is required to evaluate any complex business rules that can be processed on the view tier is also extracted. This means that once the data has been fetched from the server, any program logic can be executed on in-memory data. The only exceptions are lookup and decode rules. Lookup and decode rules are necessary during a data entry session to enable the user to identify a code from a description (lookup) or to obtain related information from entering a code (decode). For example, during an order entry session an user may not know the customer code and may will to search a given customer by name. Alternatively, the user may know the code but may require additional information about the customer to be displayed next to the code when the code has been entered. In this case data must be fetched on demand from the server and all events associated with the new data must be processed. The Mapper 40 automatically identifies the dependencies between items implied in lookup and decode rules and automatically sets up repository information to register those dependencies. In this way the Technology Adapters will be able to generate specific database access code to manage those events. These specifications are also network optimized, so that if entering a code causes the retrieval of data from multiple tables, all the data will be fetched in a single request to the database.

With regard to the second goal, a dependency list is built for all complex rules that target items in the view. For example, if a rule states that given an order, the payment code by default should be that of the customer, then a developer may enter the rule in this way, as shown in FIG. 9, by choosing DEFAULT as the type of rule to be applied to the payment code in the order form and entering a value expression like: customer.paymentCode. In this way the Mapper 40 would identify a dependency between the customer payment code and the order payment code and would require this data item to be extracted from the database in order to be able to apply this rule. At the same time the Mapper 40 would identify a decode dependency between the customer code and the customer payment code so that whenever a customer code is entered/changed then the application would also fetch the new payment code from the customer table. In this way, when the user enters a customer code, the application automatically retrieves the corresponding payment code and fires the default rule that assigns this code to the order payment code. All of this is enabled by the Mapper.

Achieving the third goal is now trivial since, once the complete set of data items is identified then it is easy to determine which table usages need updates by determining the editability of each item. Then the Mapper 40 determines the parent/children relationships between the updateable Business Objects in the view and sequences the API calls so that parents are created before the children and the children, upon inserting new rows in the database, correctly inherit the parent primary keys.

The output of the Mapper 40 is provided as input data to the Technology Adapter 50, which is in charge of generating the actual source code modules, interpreting the available specifications and translating them into actual source code 60 for a particular software platform.

Technology Adapters are independent from specific business rules, but know how to understand them in a general form. Formally speaking, the technology adapters depend on the business rules meta-model and not on specific business rule instances. In this way it is possible to implement any kind of business application from the same application framework, and, at the same time, to implement the same application for different hardware/software platforms by simply replacing the underlying application framework.

A Technology Adapter comprises three modules, namely: active templates 51, data objects 52 and the code generator 53. The code generator is the same for all Technology Adapters.

A Technology Adapter is structured as a tree of active templates. An active template is a text snippet, written in any formal language and stored in the repository, which defines the generic design of a piece of code. There is one active template, the root template, from which the generation of the code of a given application module type is started. Any template can reference one or more other templates, which in turn can reference other templates. In this way a tree (or network) of templates is defined starting from the root.

Invoking a data object method makes a reference from a template to another template. A data object is a code module that abstracts the repository-stored information by exposing a standardized programming interface on top of it. The method can decide whether to activate one or more given templates whose names are received by the method as parameters (templates are identified by name). So, data object methods dynamically activate the generation of given templates based on the information stored in the repository.

A specific application module source code is thus produced from the traversal of the templates tree starting from the root, driven by the execution of data object methods, which in turn are driven from the business rules and Mapper 40 derived low-level specifications stored in the repository.

The code generator is a generic module that drives the code generation process activating the root template and supplying various runtime services to templates and data objects.

In the preferred embodiment, the development environment and the generated runtime application is written in Java. This choice offsets the platform dependency, since the toolkit runs on any platform supporting Java, in particular Unix™ or Linux™, Windows™, and so on.

In particular, active templates, the data objects and the code generator are currently implemented as Java classes. A utility is provided that “compiles” the textual templates stored in the repository into executable Java classes. Data Objects are derived from other abstract classes, which are automatically generated starting from the repository structure. The bottom class data object methods are hand written, as is the code generator runtime.

To clarify the way the code generation process works an example is provided through a simple template, shown in table 2, written to generate a PL/SQL (an Oracle proprietary language) package specification of a lookup database access module.

```
TABLE 2
CREATE OR REPLACE PACKAGE
<#viewSchemaName>.<#viewName>_D IS
  -- package for view ID <#viewId>
  -- generated on: <#currentTime>
PROCEDURE queryDo(<#selectors(‘BROAD10_QUERY_PARMS’)>
```

| <#sqls.allBinds(‘BROAD10_QUERY_PARMS’)> | |
|---|---|
| pAccess | IN NUMBER, |
| pBoatReturned | IN VARCHAR2, |

pCodeTable IN OUT NOCOPY brunapi10.codeTable);

END;

The items shown in italic text represent the data object methods calls. A call is defined by embedding it inside <# and > markers. The rest of the text is static and is transferred into the generated code as is. Data object methods are of five types:

1. Accessors: these methods simply substitute formatted repository information in place of them in the generated code;

2. Iterators: these methods iterate over a collection of data objects, eventually filtering it, and for each one of them they execute a given template;

3. Navigators; these methods navigate the repository data model in order to execute a template in the context of a different data object. These methods are frequently chained to others through the operator as in the supplied example (sqls);

4. Binary; these controls evaluate a condition and generate one of two mutually exclusive templates based on the result of the condition evaluation;

5. Utility: methods that perform specific functions like installing the generated code.

In the example certain accessors (viewSchemaName, viewName, currentTime, viewId) can be found, together with one navigator (sqls) and two iterators (selectors, and allBinds);

The compiled Java version for this template is shown in Table 3:

TABLE 3

```
package broadware;
public final class BROAD10_PLS_PKS_DL extends Template {
  public void execute(
    Manager pManager,
    DataObject pDataObject
  ) {
    BoViews mData = (BoViews)pDataObject;
    pManager.addCode(”CREATE OR REPLACE PACKAGE ”);
    mData.viewSchemaName( );
    pManager.addCode(”.”);
    mData.viewName( );
    pManager.addCode(”_D IS\n -- package for view ID ”);
    mData.viewId( );
    pManager.addCode(” \n -- generated on: ”);
    mData.currentTime( );
    pManager.addCode(” \n PROCEDURE queryDo(”);
    mData.selectors(”BROAD10_QUERY_PARMS”);
    pManager.addCode(”\n ”);
    mData.getSqls( ).allBinds(”BROAD10_QUERY_PARMS”);
    pManager.addCode(”\n pAccess IN NUMBER,
\n pBoatReturned IN VARCHAR2,
\n pCodeTable IN OUT NOCOPY brunapi10.codeTable);
\nEND;”);
  }
}
```

The above code demonstrates the logic of the process, and it depends on a set of additional ancillary classes that are not shown and are not relevant in the present specification. A template has a data object as its context. When a data object method is found it is called and the name of the child template is passed along. The method then performs some logic and either adds code to the output file directly or calls other templates to do so. At the end of the process a complete source code file is generated that implements a business component according to the defined templates design and application business rules.

Templates are replaceable and data objects are extensible, so that it is possible to change the Adapter in use to create a different application implementation from the same set of repository-generated specifications. This may be required in order to port the application to multiple platforms (e.g. Unix and Windows 2000) or to simply generate an application that targets different end user devices, like mobile phones, or connectivity and compatibility requirements, for instance Intranet or Internet applications.

Going back to the wheat selling firm constraint rule example mentioned before and supposing that, for instance, the chosen Technology Adapter 50 is the one for PL/SQL code, then the generated code would be similar to the snippets listed in the following tables:

TABLE 4
code generated for the constraint check function on contract lines

```
FUNCTION chkQUANTITY_TYPE(pID IN NUMBER) RETURN
INTEGER IS
    CURSOR c0(cpID NUMBER) IS
    SELECT
      A1.QUANTITY A1_QUANTITY,
      A0.QUANTITY_MAX A0_QUANTITY_MAX
    FROM
      CONTRACT_LINES A0,
      CONTRACTS A1
    WHERE A0.ID = cpID
    AND A1.NUMBER = A0.CONTRACT_NUMBER;
  mC0 c0%ROWTYPE;
BEGIN
  OPEN c0(pID);
  FETCH c0 INTO mC0;
  IF c0%NOTFOUND THEN
    CLOSE c0;
    RETURN NULL;
  END IF;
  CLOSE c0;
  IF NOT (NOT (mC0.A1_QUANTITY <> 0) OR (mC0.A1_{—}
  QUANTITY <> 0)
  AND (mC0.A0_QUANTITY_MAX = 0)) THEN
    RETURN 0;
  ELSE
    RETURN 1;
  END IF;
END;
```

TABLE 5
automatically generated code, to be executed after the insertion of a
contract line

```
/*
If quantity is declared in the contract header, it cannot be declared
also in the order lines
*/
    IF chkQUANTITY_TYPE(mrow.ID) = 0 THEN
      brunapi09.doError(‘BG$BOCN_69’);
    END IF;
```

TABLE 6
automatically generated code, to be executed after an update on a
contract line

```
/*
If quantity is declared in the contract header, it cannot be declared
also within the lines
*/
    IF oldrow.QUANTITY_MAX = mrow.QUANTITY_MAX
    OR (oldrow.QUANTITY_MAX IS NULL AND
    mrow.QUANTITY_MAX IS NULL)
THEN
  NULL;
    ELSE
      IF chkQUANTITY_TYPE(mrow.ID) = 0 THEN
        brunapi09.doError(‘BG$BOCN_69’);
      END IF;
    END IF;
---
```

TABLE 7
automatically generated code, to be executed upon change of the
contract header

```
IF oldrow.QUANTITY_MAX = mrow.QUANTITY_MAX
OR (oldrow.QUANTITY_MAX IS NULL AND mrow.QUANTITY_{—}
MAX IS NULL) THEN
  NULL;
ELSE
  FOR c IN (
    SELECT A1.ID
    FROM CONTRACT_LINES A1
    WHERE A1.CONTRACT_NUMBER = mrow.NUMBER)
  LOOP
/*
If quantity is declared in the contract header, it cannot be declared
also within the lines
*/
    IF CONTRACT_LINES_G.chkQUANTITY_{—}
    TYPE(c.ID) = 0 THEN
      brunapi09.doError(‘BG$BOCN_69’);
    END IF;
  END LOOP;
END IF;
```

The above example clearly shows the difference between the use of a rule and the writing of code that achieves the same results. In the first case the requirement is entered in an easy way, which is independent from the target platform, the burden of generating the source code being fully sustained by the Technology Adapters; in the second case source must be written by the programmer taking care of modifying all the parts that are affected by a change in the rule.

In a preferred embodiment of the present invention, a standard Internet browser is used to accomplish development tasks with a point-and-click, easy to use, user interface. By coupling this capability with the already mentioned business rules approach the invention enables business professionals to effectively use the tool.

Summarizing, the system according to the present invention permits direct representation of the requirements of a given organization or set of organizations, in terms of three fundamental concepts: business actors, business processes and business objects. For instance, considering a company or group of companies that need to implement a set of integrated business processes, the related processes involve data, rules, people and/or computer services. Processes are represented as coordinated workflows of information objects: the system represents this data as views of basic information objects called Business Objects.

In a preferred embodiment of the system and method according to the present invention, the designer by means of an interactive tool, which prevents the introduction of an erroneous or incomplete specifications, enters the business rules of the application in the correct formalism. Generation of the final source code is accomplished by means of Technology Adapters, which do not require the intervention of a programmer since all of the programming skills are embodied in the templates and data objects that make the Technology Adapter.

As already mentioned, the capability to separate business requirements from their actual software based implementation is a second source of significant innovation that the present invention brings forward. This capability enables a development organization to reach the goal of reuse, not in terms of reuse of software, with a much broader significance of reuse of business rules and development frameworks. As every development organization knows, the identification and formalization of an application's business rules can take nearly 60% of the time required to create a new application. So, the only way of reducing business software development costs is to manage the application business rules independently of the software artifacts that embed them, so that they can be automatically reused in the future to create completely new software designs. This is exactly what this invention allows a development organization to do.

Many business application frameworks on the market today are available as class libraries. This kind of development, while enabling customization up to a given extent, at the same time requires highly trained developers to be practiced. Within this approach, business rules are inextricably intertwined with their technology implementation and are not easy to change, nor is the technology on which their implementation is based.

Almost all business software development tools today require a bloated development environment to be installed on each and every application developer's workstation. Since nearly every tool on the market is based on procedural programming approaches, the skills required to use the tool are difficult to develop and are generally not common among business professionals. This makes application development difficult since business professionals cannot directly collaborate on development and, at the same time, developers need to understand the business rules to effectively write the code. This is one of the biggest sources of problems in software development projects since communication between business professionals and application developers is not easy and often is a cause of misunderstandings, delays and low quality software.

On the contrary, the development system according to the present invention can be learned and used not only by software developers, but also, and mostly, by business professionals. The fact that the tool is accessible through a standard Internet browser allows anyone within the company, provided he has been granted access to the repository information, to know which business rules are in use at the organization and how processes work. This allows the businessman to propose changes and even implement them.

Clearly, several modifications will be apparent to and can readily be made by the skilled in the art without departing from the scope of the present invention. Therefore, the scope of the claims shall not be limited by the illustrations or the preferred embodiments given in the description in the form of examples, but rather the claims shall encompass all of the features of patentable novelty that reside in the present invention, including all the features that would be treated as equivalents by the skilled in the art.

What is claimed is:

1. Method for specifying and implementing business applications comprising a data warehouse, an application core and a graphical user interface, using modular, intercommunicating objects, comprising the steps of:
providing a plurality of database tables within said data warehouse;
starting from said plurality of database tables, generating a number of business objects stored in said repository;
accepting input from users defining a plurality of business rules associated with said business objects;
parsing and normalizing said input from users and updating said business objects within said repository;
generating source code for said application core and said graphical user interface.

2. The method of claim 1, further comprising the step of providing a formal language to write business rules.

3. The method of claim 1, wherein said at least one runtime application module performs the following operations:
processing input/output visual events from/to widgets;
creating and deleting views and widgets;
interfacing with the application core by exchanging parameters and values and calling functions to be used for computation according to said business rules.

4. The method of claim 1, wherein said active templates specify the application's behavior and the reaction to events.

5. Computer system for specifying and implementing business applications comprising a data warehouse, an application core and a graphical user interface, using modular, intercommunicating objects, comprising:
a repository of meta-data comprising business objects and application rules;
a plurality of database tables within said data warehouse;
a plurality of business rules;
means for parsing and normalizing said meta-data according to said tables and to said business rules;
means to generate source code for said application core and said graphical user interface;
means for compiling said source code to generate at least one runtime application module.

6. The system of claim 5, further comprising a formal language to write said business rules.

7. The system of claim 6, further comprising a visual tool to assist the writing said business rules.

8. The system of claim 5, wherein said means for parsing and normalizing said meta-data comprise a parser and a mapper.

9. The system of claim 5, wherein said means generating source code comprise technology adapters.

10. The system of claim 9, wherein said technology adapters comprise active templates, controls and code generators.

11. The system of claim 10, wherein said active templates specify the application's behavior and the reaction to events.

12. The system of claim 5, wherein said at least one runtime application module comprises means for:
processing input/output visual events from/to widgets;
creating and deleting views and widgets;
interfacing with the application core by exchanging parameters and values and calling functions to be used for computation according to said business rules.
